(19) United States
(12) Patent Application Publication
(10) Pub. No.: US 2025/0260029 A1
(43) Pub. Date: Aug. 14, 2025

(54) FUEL CELL SYSTEM

(71) Applicant: TOYOTA JIDOSHA KABUSHIKI KAISHA, Toyota-shi (JP)

(72) Inventors: Susumu HASHIMOTO, Ebina-shi (JP); Satoshi ANDOH, Fuji-shi (JP); Ryuhei KATAOKA, Nisshin-shi (JP); Dai HORIGUCHI, Sunto-gun (JP)

(73) Assignee: TOYOTA JIDOSHA KABUSHIKI KAISHA, Toyota-shi (JP)

(21) Appl. No.: 19/019,488

(22) Filed: Jan. 14, 2025

(30) Foreign Application Priority Data
Feb. 9, 2024 (JP) 2024-018828

(51) Int. Cl. H01M 8/04111; H01M 8/0438; H01M 8/04701; H01M 8/04746

(52) U.S. Cl. CPC H01M 8/04111; H01M 8/04425; H01M 8/04708; H01M 8/04753; H01M 8/04776

(57) ABSTRACT

The fuel cell system includes a plurality of fuel cell stacks, an oxidant gas supply unit having a turbo compressor that supplies oxidant gas to each of the fuel cell stacks, and a control device that determines a required operation number for the fuel cell stacks and a target supply pressure and a target supply flow rate of oxidant gas to be commanded to the oxidant gas supply unit according to a required output. The oxidant gas supply unit has an adjustment mechanism that adjusts a supply rate, which is a ratio of a supply flow rate supplied to the plurality of fuel cell stacks, with respect to a discharge flow rate of the turbo compressor. The control device monitors the pressure ratio in the turbo compressor and controls the adjustment mechanism to reduce the supply rate when the pressure ratio exceeds a predetermined threshold.

### CROSS-REFERENCE TO RELATED APPLICATION

This application claims priority to Japanese Patent Application No. 2024-018828 filed on Feb. 9, 2024, incorporated herein by reference in its entirety.

### BACKGROUND

### 1. Technical Field

The technology disclosed by the present specification relates to a fuel cell system.

### 2. Description of Related Art

Japanese Unexamined Patent Application Publication No. 2022-156906 (JP 2022-156906 A) describes a fuel cell system. The fuel cell system includes a plurality of fuel cell stacks, an oxidant gas supply unit that supplies an oxidant gas to each of the fuel cell stacks, a cooling unit that supplies a refrigerant for cooling each of the fuel cell stacks, and a control device that determines a target supply flow rate of the oxidant gas to be commanded to the oxidant gas supply unit and a target supply flow rate of the refrigerant to be commanded to the cooling unit.

### SUMMARY

In the fuel cell stack, a supply pressure and a supply flow rate of the oxidant gas to be supplied to the fuel cell stack are determined in accordance with a required output (namely, generated power) and the temperature of the fuel cell stack. For example, if the temperature of the fuel cell stack is constant, it is necessary to increase the supply pressure and the supply flow rate of the oxidant gas as the required output for the fuel cell stack increases. At this time, if a turbo compressor is adopted for a supply of the oxidant gas, there is a fear that surging occurs due to a pressure ratio in the compressor increasing. In particular, in a fuel cell system that includes a plurality of fuel cell stacks, the number of fuel cell stacks to be operated may be reduced, in accordance with a required output for the entire system. In this case, in a fuel cell stack that continues an operation, since the required output rapidly increases, there is a high risk that surging occurs.

In view of the circumstances, the present specification provides technology to avoid surging of a turbo compressor.

As described, when the required output for a fuel cell stack increases, it is necessary to increase the supply pressure and the supply flow rate of the oxidant gas to the fuel cell stack. Accordingly, in the turbo compressor, it is necessary to increase a pressure ratio and a discharge flow rate of the oxidant gas. In relation to this point, in a turbo compressor, there is a high risk that surging occurs by having the pressure ratio exceed a certain upper limit value. However, the upper limit value is not constant, and the upper limit value increases as the discharge flow rate of the turbo compressor increases. Therefore, when the pressure ratio in the turbo compressor increases, surging of the compressor can be avoided if the discharge flow rate of the oxidant gas in the turbo compressor can also be increased. Also, oxidant gas of an appropriate amount can be supplied to the fuel cell stack if a ratio of the supply flow rate supplied to the fuel cell stack with respect to the discharge flow rate of the oxidant gas in the compressor can be adjusted.

Based on the findings, the technology disclosed in the present specification is embodied in a fuel cell system. In a first aspect,
a fuel cell system includes
a plurality of fuel cell stacks,
an oxidant gas supply unit having a turbo compressor that supplies an oxidant gas to each of the fuel cell stacks, and
a control device that determines a required operation number for the fuel cell stacks and a target supply pressure and target supply flow rate of the oxidant gas to be commanded to the oxidant gas supply unit in accordance with a required output, in which
the oxidant gas supply unit has an adjustment mechanism that adjusts a supply rate being a ratio of a supply flow rate supplied to the fuel cell stacks with respect to a discharge flow rate of the turbo compressor.

The control device monitors a pressure ratio in the turbo compressor, and reduces the supply rate by controlling the adjustment mechanism when the pressure ratio exceeds a predetermined threshold.

According to the configuration, by reducing the number of fuel cell stacks to be operated (namely, to generate electricity), for example, the discharge flow rate of the oxidant gas in the turbo compressor can be preferentially increased, when the pressure ratio in the turbo compressor increases. As a result, surging of the turbo compressor can be avoided.

In a second aspect, in the first aspect,
the adjustment mechanism may include
a recirculation path that connects a discharge side and a suction side of the turbo compressor to each other, and
a flow rate adjustment valve provided in the recirculation path.

According to the configuration, the oxidant gas can be sent from the discharge side to the suction side via the recirculation path, and the discharge flow rate of the oxidant gas in the turbo compressor can be preferentially increased.

In a third aspect, in the first or second aspect,
the oxidant gas supply unit may further include an intercooler that cools the oxidant gas discharged from the turbo compressor.

In this case, the recirculation path may connect the discharge side and the suction side of the turbo compressor to each other on an upstream side of the intercooler.

According to the configuration, since the oxidant gas sent from the discharge side to the suction side does not pass through the intercooler, only the oxidant gas supplied to the fuel cell stack can be cooled by the intercooler.

In a fourth aspect, in the first or second aspect,
the oxidant gas supply unit may further include an intercooler that cools the oxidant gas discharged from the turbo compressor.

In this case, the recirculation path may connect the discharge side and the suction side of the turbo compressor to each other on a downstream side of the intercooler.

According to the configuration, the temperature of the oxidant gas sucked in by the turbo compressor is lowered, and energy required for realizing a predetermined pressure ratio in the compressor can be reduced.

In a fifth aspect, in any one of the first to fourth aspects,
the oxidant gas supply unit may include an oxidant gas supply path that supplies the oxidant gas from the turbo compressor to the fuel cell stacks, and
an off-gas discharge path that discharges an off-gas of the oxidant gas from the fuel cell stacks.

In this case, the adjustment mechanism may include a flow dividing path that connects the oxidant gas supply path and the off-gas discharge path to each other, and a flow rate adjustment valve provided in the flow dividing path.

According to the configuration, the oxidant gas can be discharged from the oxidant gas supply path to the off-gas discharge path via the flow dividing path, and the discharge flow rate of the oxidant gas in the turbo compressor can be preferentially increased.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of a fuel cell system 10 according to a first embodiment;

FIG. 2 is a diagram illustrating a relationship between a target supply pressure and a target supply flow rate of the oxidant gas that the control device 36 instructs the oxidant gas supply unit 20 in accordance with the output required for the fuel cell stacks 12 and 14;

FIG. 3 shows a surging restriction line SL of the compressor 22;

FIG. 4 is a flowchart showing a first process executed by the control device 36;

FIG. 5 shows changes over time of various parameters in the first process shown in FIG. 4;

FIG. 6 is a flowchart showing a second process executed by the control device 36;

FIG. 7 is a diagram schematically illustrating a configuration of a fuel cell system 110 according to a second embodiment; and

FIG. 8 is a diagram schematically illustrating a configuration of a fuel cell system 210 according to a third embodiment.

### DETAILED DESCRIPTION OF EMBODIMENTS

### Example 1

The fuel cell system 10 of the present embodiment will be described with reference to the drawings. The fuel cell system 10 is a power generation system that is mounted on a moving object (for example, an automobile, a bus, a truck, a train, a ship, an airplane), a stationary fuel cell device, or the like, and outputs electric power in response to an output requested from the outside.

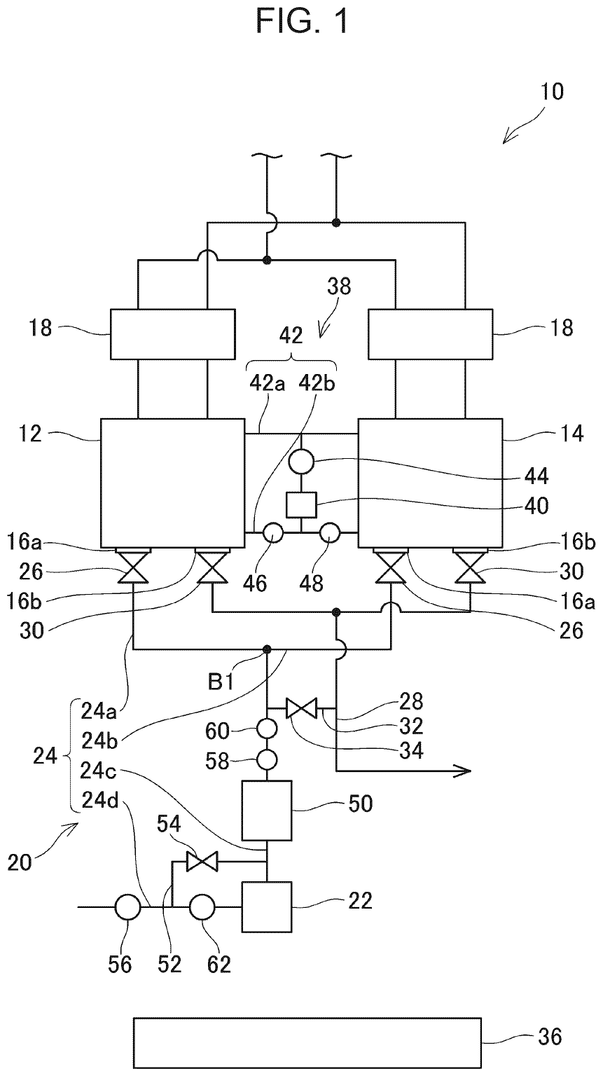

As shown in FIG. 1, the fuel cell system 10 includes a plurality of fuel cell stacks 12 and 14. Each of the fuel cell stacks 12 and 14 has a structure in which a plurality of fuel cell cells is stacked. The fuel cell stacks 12 and 14 include an anode-side supply port (not shown), a cathode-side supply port 16a, an anode-side discharge port (not shown), and a cathode-side discharge port 16b. The anode-side supply port and the cathode-side supply port 16a of the fuel cell stacks 12 and 14 are connected to each of the plurality of fuel cell cells in the fuel cell stacks 12 and 14. The fuel cell stacks 12 and 14 generate electric power by chemically reacting the fuel gas taken in from the anode-side supply port and the oxidant gas taken in from the cathode-side supply port 16a in the plurality of fuel cell cells. Gases (i.e., off-gas) that have passed through the plurality of fuel cell stacks 12 and 14 are discharged to the outside from the anode-side discharge port and the cathode-side discharge port 16b.

The plurality of fuel cell stacks 12, 14 includes a first fuel cell stack 12 and a second fuel cell stack 14. In the present embodiment, the first fuel cell stack 12 is electrically connected in parallel to the second fuel cell stack 14. However, the number of the plurality of fuel cell stacks 12 and 14 is not particularly limited, and may be two or more. In the fuel cell system 10 of the present embodiment, hydrogen gas is used as the fuel gas, and air is used as the oxidant gas. The air contains oxygen as an oxidizing agent.

As shown in FIG. 1, the fuel cell system 10 further includes a plurality of power control units 18. In the present embodiment, the power control unit 18 includes a step-up converter. The power control unit 18 is electrically connected to each fuel cell stack 12, 14. The power control unit 18 can boost the generated power from the fuel cell stacks 12 and 14 and output the boosted power to the outside. Although not particularly limited, the power control unit 18 may further include an inverter in addition to the step-up converter.

As illustrated in FIG. 1, the fuel cell system 10 further includes an oxidant gas supply unit 20 and a control device 36. The oxidant gas supply unit 20 is a unit for supplying oxidant gas (air) to each of the plurality of fuel cell stacks 12 and 14. The oxidant gas supply unit 20 includes a compressor 22, an intercooler 50, an oxidant gas supply path 24, a plurality of inlet valves 26, an off-gas discharge path 28, a plurality of outlet valves 30, a flow dividing path 32, and a flow dividing valve 34. The control device 36 can start and stop the operation of the fuel cell stacks 12, 14.

The compressor 22 is a turbo compressor. The compressor 22 is provided in the oxidant gas supply path 24, and compresses air taken from the outside and supplies the compressed air to the plurality of fuel cell stacks 12 and 14. The oxidant gas supply path 24 is a path for supplying the oxidant gas discharged from the compressor 22 to the plurality of fuel cell stacks 12 and 14. The oxidant gas supply path 24 includes a first oxidant gas supply path 24a and a second oxidant gas supply path 24b. The first oxidant gas supply path 24a is connected to the cathode-side supply port 16a of the first fuel cell stack 12, and supplies the oxidant gas from the compressor 22 to the first fuel cell stack 12. The second oxidant gas supply path 24b is connected to the cathode-side supply port 16a of the second fuel cell stack 14, and supplies the oxidant gas from the compressor 22 to the second fuel cell stack 14. The first oxidant gas supply path 24a and the second oxidant gas supply path 24b are connected to each other at a branch point B1.

The oxidant gas supply path 24 further includes a third oxidant gas supply path 24c and a fourth oxidant gas supply path 24d. The third oxidant gas supply path 24c extends between the branch point B1 and the compressor 22, and connects the compressor 22 to the first oxidant gas supply path 24a and the second oxidant gas supply path 24b. The third oxidant gas supply path 24c is located on the discharge side of the compressor 22, and supplies the oxidant gas discharged from the compressor 22 to the first oxidant gas supply path 24a and the second oxidant gas supply path 24b. The fourth oxidant gas supply path 24d is located on the suction side of the compressor 22, and supplies the air taken from the outside to the compressor 22. Although not particularly limited, the fuel cell system 10 may further include an air cleaner that removes foreign matters such as dust and dust from the air taken from the outside.

The off-gas discharge path 28 is a path for discharging the off-gas of the oxidant gas from the plurality of fuel cell stacks 12 and 14. The off-gas discharge path 28 is connected to the cathode-side discharge port 16b in each of the plurality of fuel cell stacks 12 and 14.

The intercooler 50 is provided in the third oxidant gas supply path 24c. The intercooler 50 cools the oxidant gas discharged from the compressor 22. Thus, the oxidant gas discharged from the compressor 22 is cooled by the intercooler 50 and then supplied to the plurality of fuel cell stacks 12 and 14. The intercooler 50 may be water-cooled or air-cooled.

The plurality of inlet valves 26 are provided in the cathode-side supply port 16a in the plurality of fuel cell stacks 12 and 14, respectively. The plurality of outlet valves 30 are provided on the cathode-side discharge port 16b in the plurality of fuel cell stacks 12 and 14, respectively.

The flow dividing path 32 connects the oxidant gas supply path 24 and the off-gas discharge path 28 to each other. As an example, the flow dividing path 32 in the present embodiment branches from the third oxidant gas supply path 24c and is connected to the off-gas discharge path 28. A flow dividing valve 34 is provided in the flow dividing path 32. The inlet valve 26, the outlet valve 30, and the flow dividing valve 34 are control valves whose opening degree can be adjusted. The operation (opening degree) of the inlet valve 26, the outlet valve 30, and the flow dividing valve 34 is controlled by the control device 36. The control device 36 may control the operation of the compressor 22, the inlet valves 26, the outlet valves 30, and the flow dividing valve 34 to adjust the supply pressure and the supply flow rate of the oxidant gas supplied to the fuel cell stacks 12 and 14, respectively.

As shown in FIG. 1, the oxidant gas supply unit 20 further includes a recirculation path 52 and a recirculation valve 54. The recirculation path 52 connects the fourth oxidant gas supply path 24d located on the suction side of the compressor 22 and the third oxidant gas supply path 24c located on the discharge side of the compressor 22 to each other. A recirculation valve 54 is provided in the recirculation path 52. The operation (opening degree) of the recirculation valve 54 is controlled by the control device 36. By controlling the operation of the recirculation valve 54, the control device 36 can deliver a part of the oxidant gas discharged from the compressor 22 from the third oxidant gas supply path 24c to the fourth oxidant gas supply path 24d. Thus, the control device 36 can adjust a supply rate (hereinafter, sometimes simply referred to as a supply rate) which is a ratio of a supply flow rate supplied to the plurality of fuel cell stacks 12 and 14 with respect to a discharge flow rate of the compressor 22.

Although not shown, the fuel cell system 10 further includes a fuel gas supply unit. The fuel gas supply unit is a unit for supplying fuel gas (hydrogen gas) to the fuel cell stacks 12 and 14.

As shown in FIG. 1, the fuel cell system 10 further includes a cooling unit 38. The cooling unit 38 is a unit for cooling each of the plurality of fuel cell stacks 12 and 14. The cooling unit 38 includes a radiator 40, a circulation path 42, a pump 44, and a plurality of temperature sensors 46 and 48. The radiator 40 discharges heat from the refrigerant circulating in the circulation path 42. The circulation path 42 includes a forward path 42a for supplying the refrigerant from the radiator 40 to the fuel cell stacks 12 and 14, and a return path 42b for returning the refrigerant from the fuel cell stacks 12 and 14 to the radiator 40. The pumps 44 are provided in the forward path 42a.

The plurality of temperature sensors 46, 48 includes a first temperature sensor 46 and a second temperature sensor 48. The first temperature sensor 46 is provided at the outlet of the first fuel cell stack 12 in the return path 42b, and detects the temperature of the coolant that has passed through the first fuel cell stack 12. The second temperature sensor 48 is provided at the outlet of the second fuel cell stack 14 in the return path 42b, and detects the temperature of the coolant that has passed through the second fuel cell stack 14. The refrigerant absorbs heat from the fuel cell when passing through the plurality of fuel cell cells in the fuel cell stacks 12 and 14. Therefore, the value detected by each temperature sensor 48, i.e., the temperature of the refrigerant at the outlet of each fuel cell stack 12, 14, has a correlation with the actual temperature of the fuel cell stack 12, 14. Here, the actual temperature of the fuel cell stacks 12 and 14 means the actual temperature of the fuel cell stacks 12 and 14.

The control device 36 determines a target cooling temperature of the fuel cell stacks 12, 14 that commands the cooling unit 38. Then, the control device 36 controls the pump 44 based on the values detected by the temperature sensors 46 and 48 to adjust the flow rate of the refrigerant supplied to the fuel cell stacks 12 and 14. Accordingly, the control device 36 cools the fuel cell stacks 12 and 14 so that the temperature of the fuel cell stacks 12 and 14 becomes the target cooling temperature. In one example, the refrigerant is water. In other embodiments, the fuel cell system 10 may include a separate cooling unit 38 for each fuel cell stack 12, 14.

As shown in FIG. 1, the fuel cell system 10 further includes a first pressure sensor 56 and a second pressure sensor 58. The first pressure sensor 56 is provided in the fourth oxidant gas supply path 24d, and detects the pressure of the oxidant gas (air) sucked into the compressor 22. The second pressure sensor 58 is provided in the third oxidant gas supply path 24c, and detects the pressure of the oxidant gas (air) discharged from the compressor 22. The detection value by each pressure sensor 56, 58 is obtained by the control device 36. Based on the values detected by the pressure sensors 56 and 58, the control device 36 calculates and monitors the pressure ratio in the compressor 22.

As shown in FIG. 1, the fuel cell system 10 further includes a third temperature sensor 60 and a flow rate sensor 62. The third temperature sensor 60 is provided at the outlet of the intercooler 50 in the third oxidant gas supply path 24c. Thus, the third temperature sensor 60 detects the temperature of the oxidant gas cooled by the intercooler 50. The flow rate sensor 62 is provided in the fourth oxidant gas supply path 24d, and detects the flow rate of the oxidant gas sucked by the compressor 22. The values detected by the sensors 60 and 62 are acquired by the control device 36.

The control device 36 may change the number of fuel cell stacks 12, 14 to be operated in response to the output required of the fuel cell system 10. For example, if the output required of the fuel cell system 10 is relatively small, the control device 36 stops the operation of one of the two fuel cell stacks 12, 14. Thus, a decrease in power generation efficiency can be avoided.

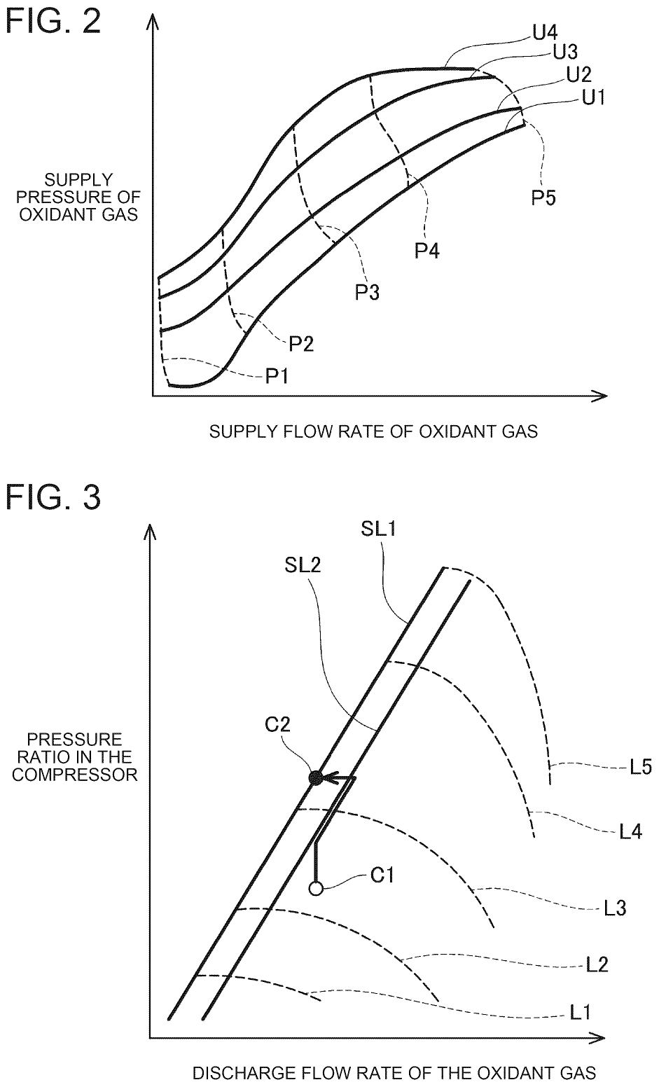

Once the number of fuel cell stacks 12, 14 to be operated is determined, the required output for each fuel cell stack 12, 14 is determined. In each fuel cell stack 12, 14, the supply pressure and the supply flow rate of the oxidant gas to be supplied to each fuel cell stack 12, 14 are determined according to the required output (i.e., generated power) and the temperature of the fuel cell stack 12, 14. FIG. 2 shows the relationship between the target supply pressure and the target supply flow rate of the oxidant gas that the control device 36 instructs the oxidant gas supply unit 20 in accordance with the output required for the fuel cell stacks 12 and 14. Each of the solid lines U1 to U4 indicates a relation between a supply flow rate of the oxidant gas and a supply pressure of the oxidant gas for different temperatures of the fuel cell stacks 12 and 14. Each of the dashed lines P1 to P5 indicates the relation between the supply flow rate of the oxidant gas and the supply pressure of the oxidant gas for the different currents (i.e., generated electric power) of the fuel cell stacks 12 and 14. The larger the number, the higher the temperature or the higher the power. As shown in FIG. 2, for example, when the temperature of the fuel cell stacks 12 and 14 is constant, the supply pressure and the supply flow rate of the oxidant gas need to be increased as the output required for the fuel cell stacks 12 and 14 increases. In particular, when the number of fuel cell stacks 12 and 14 to be operated is reduced, the required output of the fuel cell stack 12 (or 14) to be operated is rapidly increased, and therefore, the supply pressure and the supply flow rate of the oxidant gas need to be greatly increased.

In this regard, in the fuel cell system 10 of the present embodiment, a turbo compressor 22 is employed to supply the oxidant gas. FIG. 3 shows a surging restriction line SL of the compressor 22. Each of the dotted lines L1 to L5 indicates the relation between the discharge flow rate of the oxidant gases and the pressure ratio at the compressor 22 for the different rotational speeds of the compressor 22. Incidentally, the larger the number, which means that the rotational speed is larger. Increasing the pressure ratio in the compressor 22 to increase the supply pressure of the oxidant gas to the fuel cell stacks 12, 14 may cause surging of the compressor 22. Therefore, as shown in FIG. 3, in the fuel cell system 10, the surging restriction lines SL1, SL2 are defined for the operating point (combined pressure ratio and discharge flow rate) of the compressor 22. That is, if the operating point of the compressor 22 exceeds the surging restriction lines SL1, SL2, surging may occur in the compressor 22. In particular, when the power required by the fuel cell stack 12 (or 14) suddenly increases, such as when the number of operating fuel cell stacks 12, 14 decreases, the operating point of the compressor 22 is more likely to exceed the surging restriction lines SL1, SL2.

In order to avoid surging of the compressor 22, the operating point of the compressor 22 must be maintained at or below the surging restriction line SL1 (or SL2). As indicated by the surging restriction line SL1 (or SL2), in the compressor 22, surging is more likely to occur when the pressure ratio exceeds a certain upper limit. However, the upper limit value is not constant, and as the discharge flow rate of the compressor 22 increases, the upper limit value also increases. Therefore, if the discharge flow rate of the oxidant gas in the compressor 22 can also be increased when the pressure ratio in the compressor 22 increases, surging of the compressor 22 can be avoided. Even when the discharge flow rate of the oxidant gas in the compressor 22 is increased, an appropriate amount of the oxidant gas can be supplied to the fuel cell stacks 12 and 14 as long as the ratio of the supply flow rate supplied to the fuel cell stacks 12 and 14 can be adjusted with respect to the discharge flow rate.

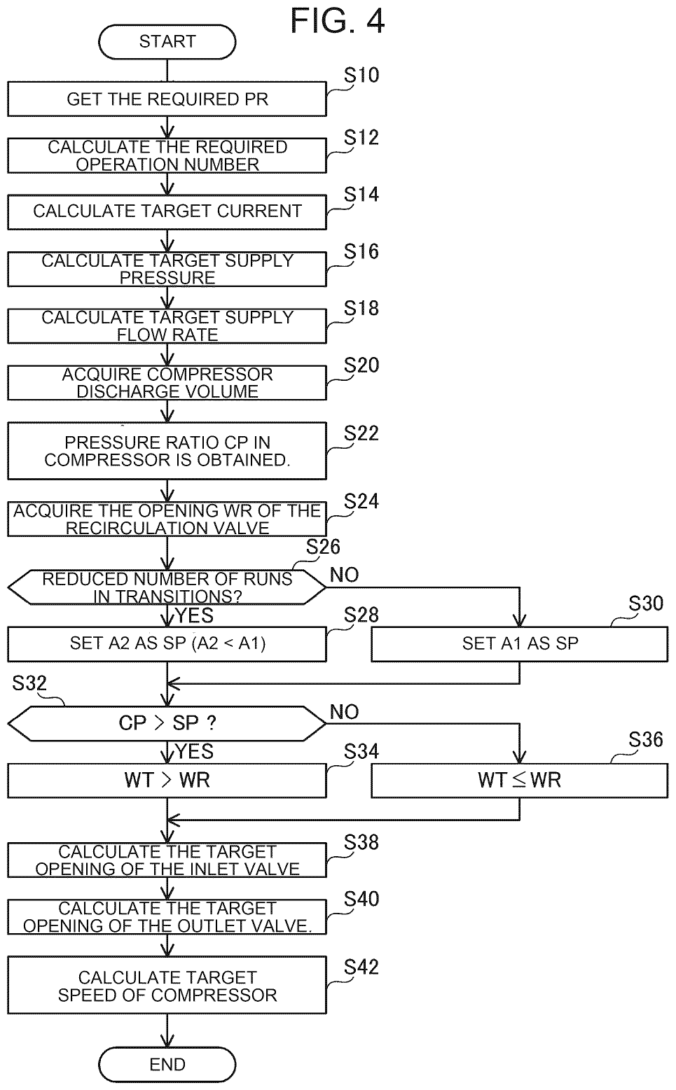

Based on this finding, the control device 36 of the present embodiment is configured to be able to repeatedly execute the first process illustrated in FIG. 4. By repeatedly executing the first process, the control device 36 can adjust the supply rate, which is the ratio of the supply flow rate to be supplied to the plurality of fuel cell stacks 12 and 14, with respect to the discharge flow rate of the compressor 22.

As illustrated in FIG. 4, the control device 36 acquires an output PR requested from the outside (S10). Based on the output PR obtained by S10, the control device 36 calculates the required operation number for the fuel cell stacks 12 and 14 (S12). Further, the control device 36 calculates a target current (i.e., a target generated power) for the fuel cell stacks 12 and 14 (S14). The control device 36 calculates the target supply pressure of the oxidant gas to be instructed to the oxidant gas supply unit 20 in accordance with the target current determined by S14 (S16), and calculates the target supply flow rate of the oxidant gas to be instructed to the oxidant gas supply unit 20 (S18). The control device 36 of the present embodiment stores in advance a map describing the relationship (see FIG. 2) between the target supply pressure and the target supply flow rate of the oxidant gas to be instructed to the oxidant gas supply unit 20. Therefore, the control device 36 calculates the target supply pressure and the target supply flow rate of the oxidant gas according to the actual operation number based on the relationship described by the map stored in advance. Thereafter, the control device 36 controls each unit according to the calculated value.

The control device 36 acquires the discharge flow rate of the compressor 22 (S20). As described above, the intake flow rate of the oxidant gas sucked into the compressor 22 is detected by the flow rate sensor 62. For example, when the pressure of the oxidant gas in the third oxidant gas supply path 24c increases, the discharge flow rate of the oxidant gas by the compressor 22 decreases. When the oxidant gas in the third oxidant gas supply path 24c decreases, the discharge flow rate of the oxidant gas by the compressor 22 increases. Then, the control device 36 can estimate the discharge flow rate of the compressor 22 from the detection value by the second pressure sensor 58 and the detection value by the flow rate sensor 62. However, as another embodiment, the fuel cell system 10 may further include a flow rate sensor that detects a discharge flow rate of the compressor 22, and the control device 36 may acquire a detection value by the flow rate sensor.

The control device 36 acquires the pressure ratio CP at the compressor 22 (S22). As described above, the control device 36 calculates and monitors the pressure ratio in the compressor 22 based on the detection values by the pressure sensors 56 and 58.

Next, the control device 36 acquires the opening degree WR of the recirculation valve 54 (S24). As described above, since the opening degree WR of the recirculation valve 54 is controlled by the control device 36, the control device 36 can acquire the opening degree WR of the recirculation valve 54.

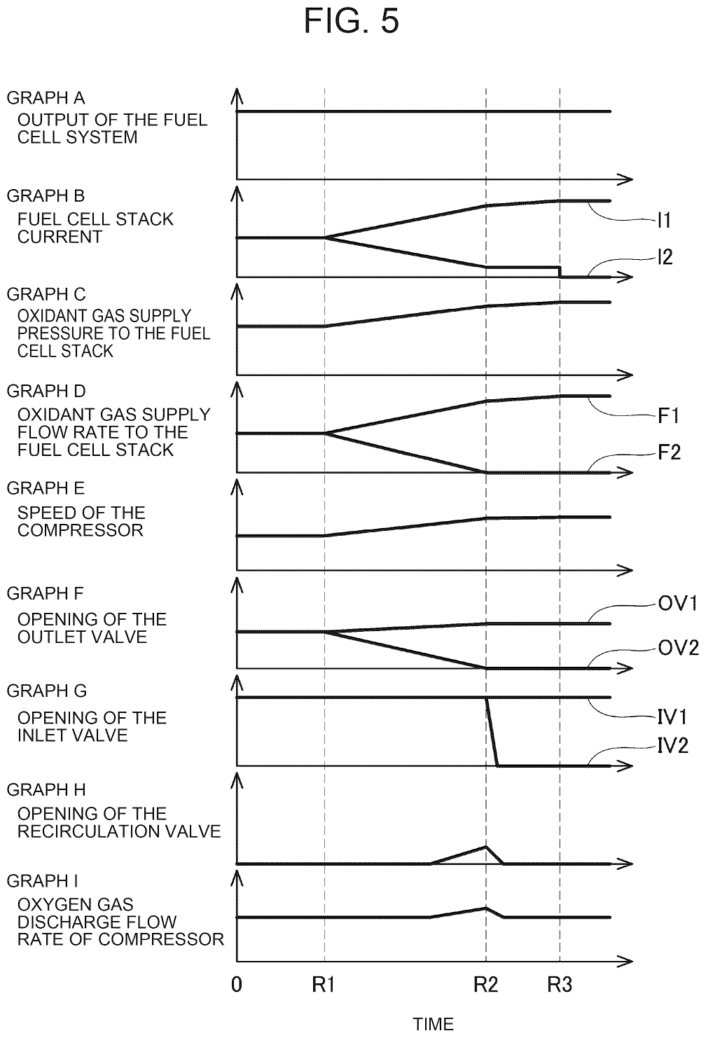

The control device 36 determines whether or not it is during the transition in which the number of operations of the fuel cell stacks 12 and 14 is reduced (S26). Here, the transition during which the number of operation of the fuel cell stacks 12 and 14 is reduced refers to a period from a state in which the two fuel cell stacks 12 and 14 are in operation to a state in which only one of the fuel cell stacks 12 and 14 is in operation (that is, a state in which the fuel cell stacks are in independent operation). In this period, as shown in the range from the time R1 to the time R3 in FIG. 5, various parameters such as the discharge flow rate of the oxidant gas by the compressor 22 are greatly varied, and surging of the compressor 22 is relatively likely to occur. Graphs A to I in FIG. 5 show changes over time in various parameters in the first process shown in FIG. 4. In graph B of FIG. 5, the curve I1 indicates the current of the first fuel cell stack 12, and the curve 12 indicates the current of the second fuel cell stack 14. In the graph E of FIG. 5, the curve OV1 indicates the opening degree of the outlet valve 30 of the first fuel cell stack 12, and the curve OV2 indicates the opening degree of the outlet valve 30 of the second fuel cell stack 14. In the graph F of FIG. 5, the curve IV1 indicates the opening degree of the inlet valve 26 of the first fuel cell stack 12, and the curve IV2 indicates the opening degree of the inlet valve 26 of the second fuel cell stack 14.

If NO in S26, the control device 36 sets the first pressure value A1 as the surging restriction pressure SP (S30). In S30, the control device 36 first adopts the first surging restriction line SL1 shown in FIG. 3 as the surging restriction line SL. The control device 36 determines, on the first surging restriction line SL1, a pressure value that becomes the discharge flow rate of the compressor 22 acquired by S20 as the first pressure value A1.

On the other hand, when S26 is YES, the control device 36 sets the second pressure value A2 as the surging restriction pressure SP (S28). In S28, the control device 36 first adopts the second surging restriction line SL2 as the surging restriction line SL. The control device 36 determines, on the second surging restriction line SL2, a pressure value that becomes the discharge flow rate of the compressor 22 acquired by S20 as the second pressure value A2. The second pressure value A2 is a value smaller than the first pressure value A1. As shown in FIG. 3, the second surging restriction line SL2 corresponds to the first surging restriction line SL1 moved downward. Therefore, when the discharge flow rate of the compressor 22 is constant, when the second surging restriction line SL2 is adopted, the surging restriction pressure SP is set to be smaller than when the first surging restriction line SL1 is adopted. Thereby, surging of the compressor 22 is more reliably avoided.

The control device 36 determines whether or not the pressure ratio CP in the compressor 22 acquired by S22 exceeds the surging restriction pressure SP set by S28 or S30 (S32). When S32 is YES, the control device 36 sets the target opening degree WT of the recirculation valve 54 to be larger than the opening degree WR of the recirculation valve 54 acquired by S24 (S34). As a result, the opening degree of the recirculation valve 54 is increased, and the oxidant gas delivered from the third oxidant gas supply path 24c to the fourth oxidant gas supply path 24d among the oxidant gas discharged from the compressor 22 is increased. That is, the supply rate decreases. When S32 is NO, the control device 36 sets the target opening degree WT of the recirculation valve 54 to be equal to or less than the opening degree WR of the recirculation valve 54 acquired by S24 (S36).

The control device 36 calculates a target opening degree to be instructed to the inlet valve 26 of the oxidant gas supply unit 20 (S38) and calculates a target opening degree to be instructed to the outlet valve 30 of the oxidant gas supply unit 20 (S40). Next, the control device 36 calculates a target rotational speed to be instructed to the compressor 22 (S42). The control device 36 controls each unit according to the calculated value, and ends one cycle of the first process illustrated in FIG. 4.

According to the above-described configuration, by decreasing the number of fuel cell stacks 12 and 14 to be operated (that is, to generate electric power), it is possible to preferentially increase the discharge flow rate of the oxidant gas in the compressor 22 when the pressure ratio in the compressor 22 increases. Thus, surging of the compressor 22 can be avoided. In particular, in the first process shown in FIG. 4, the oxidant gas can be delivered from the discharge side to the suction side via the recirculation path 52, whereby the discharge flow rate of the oxidant gas in the compressor 22 can be preferentially increased (see FIG. 5). Note that the recirculation path 52 and the recirculation valve 54 in the present specification are examples of the adjustment mechanism in the present technology. The first pressure value A1 and the second pressure value A2 in the present specification are examples of predetermined thresholds with respect to the pressure ratio in the turbo compressor in the present technology.

In this embodiment, the oxidant gas supply unit 20 includes an intercooler 50 that cools the oxidant gas discharged from the compressor 22. The recirculation path 52 connects the fourth oxidant gas supply path 24d located on the suction side of the compressor 22 and the third oxidant gas supply path 24c located on the discharge side of the compressor 22 to each other. In particular, in the third oxidant gas supply path 24c, the recirculation path 52 is connected upstream side of the intercooler 50. According to such a configuration, since the oxidant gas delivered from the discharge side to the suction side does not pass through the intercooler 50, only the oxidant gas supplied to the fuel cell stacks 12 and 14 can be cooled by the intercooler 50.

In the above-described first process, the threshold value (here, the second pressure value A2) with respect to the pressure ratio in the compressor 22 is set to be low during the transition in which the number of operations of the fuel cell stacks 12 and 14 is reduced. During the transition in which the number of operations of the fuel cell stacks 12 and 14 is reduced, the discharge flow rate of the oxidant gas in the compressor 22, the pressure ratio in the compressor 22, and the like greatly fluctuate, so that surging is relatively likely to occur. Therefore, according to the above-described configuration, it is possible to more reliably avoid surging of the compressor 22 even during a transition in which the number of operations of the fuel cell stacks 12 and 14 is reduced. In the first process illustrated in FIG. 4, the control device 36 may omit the process from S26 to S30. That is, in other embodiments, the control device 36 may not set the threshold for the pressure ratio at the compressor 22 low during the transition to reduce the number of fuel cell stacks 12, 14 operations.

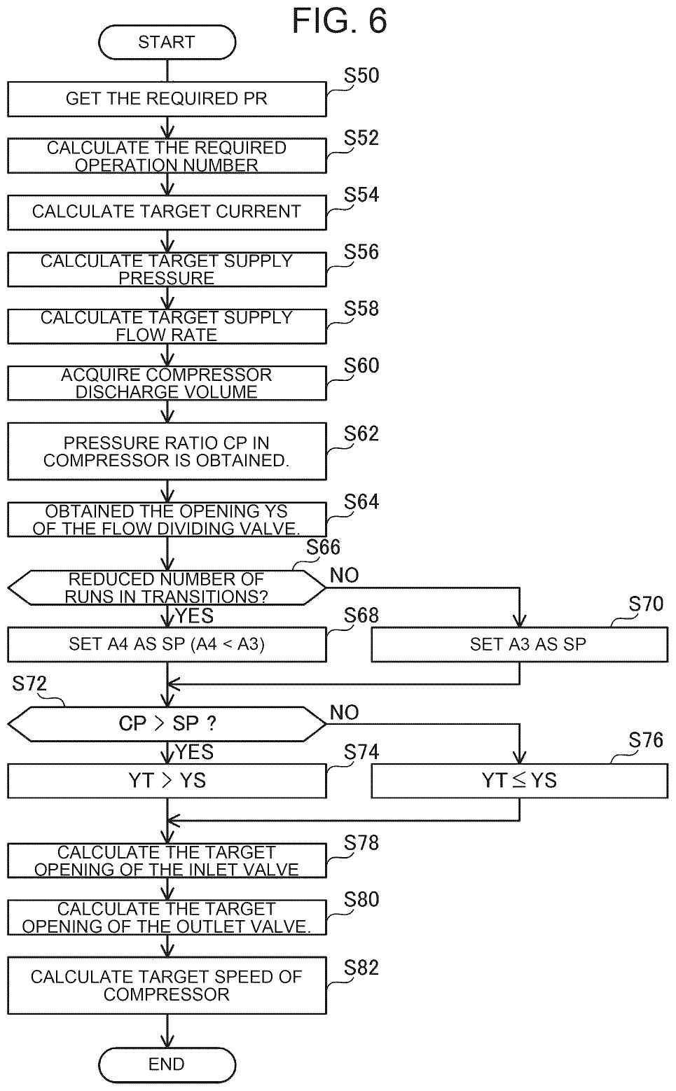

In addition, based on the same knowledge, the control device 36 of the present embodiment is configured to be able to repeatedly execute the second process illustrated in FIG. 6. In the second process, the flow dividing path 32 and the flow dividing valve 34 are used instead of the recirculation path 52 and the recirculation valve 54 of the first process shown in FIG. 4. This makes it possible to adjust the supply rate, which is the ratio of the supply flow rate to be supplied to the plurality of fuel cell stacks 12 and 14, with respect to the discharge flow rate of the compressor 22. Each step from S50 to S82 in the second process corresponds to each step from S10 to S42 in the first process. In the second process, the third pressure value A3 or the fourth pressure value A4 is set as the surging restriction pressure SP (S78, S80), and the fourth pressure value A4 is a value smaller than the third pressure value A3.

According to such a configuration, by reducing the number of fuel cell stacks 12, 14 to be operated (i.e., to generate electricity), when the pressure ratio in the compressor 22 increases, the oxidant gas can be discharged from the oxidant gas supply path 24 to the off-gas discharge path 28 via the flow dividing path 32. Thus, the discharge flow rate of the oxidant gas in the compressor 22 can be preferentially increased. Here, the flow dividing path 32 and the flow dividing valve 34 in the present specification are examples of the adjustment mechanism in the present technology. The third pressure value A3 and the fourth pressure value A4 in the present specification are examples of predetermined thresholds with respect to the pressure ratio in the turbo compressor in the present technology.

Although not particularly limited, in the first process illustrated in FIG. 4, the control device 36 may preferentially increase the discharge flow rate of the oxidant gas in the compressor 22 by using the flow dividing path 32 and the flow dividing valve 34 in addition to the recirculation path 52 and the recirculation valve 54.

### Example 2

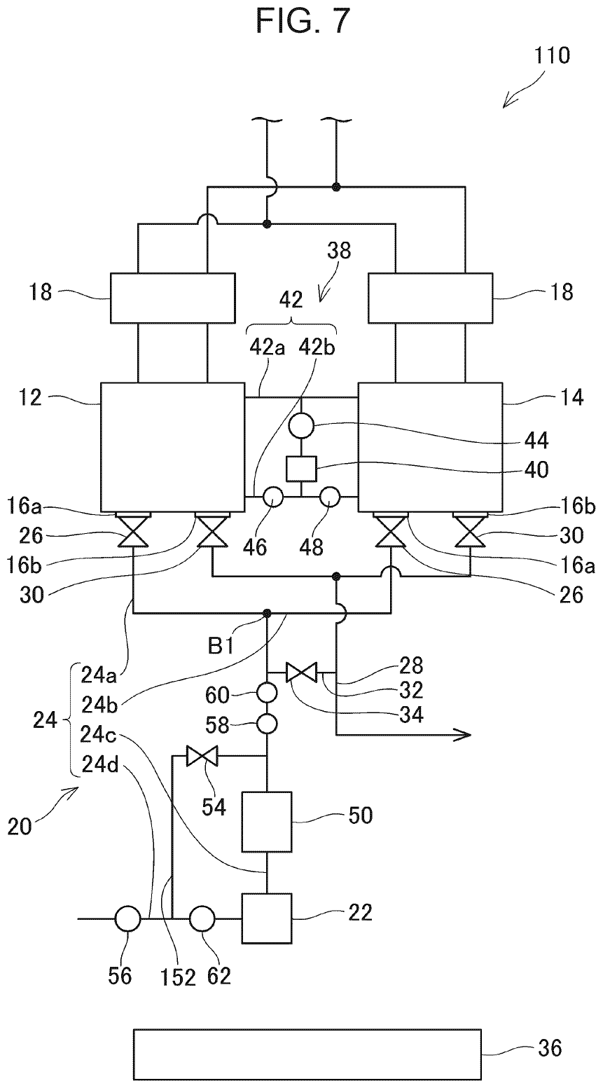

The fuel cell system 110 of the second embodiment will be described with reference to FIG. 7. As shown in FIG. 7, in the fuel cell system 110 of the second embodiment, the position where the recirculation path 152 is provided is changed as compared with the fuel cell system 10 of the first embodiment. The remainder of the configuration is the same as that of the fuel cell system 10 of the first embodiment, and therefore, a repetitive description thereof will be omitted here.

As shown in FIG. 7, the recirculation path 152 connects the fourth oxidant gas supply path 24d located on the suction side of the compressor 22 and the third oxidant gas supply path 24c located on the discharge side of the compressor 22 to each other. In particular, in the third oxidant gas supply path 24c, the recirculation path 152 is connected downstream side of the intercooler 50.

Also in the above-described configuration, the control device 36 can repeatedly execute the first processing and/or the second processing in the first embodiment. Thus, surging of the compressor 22 can be avoided. In particular, as described above, since the recirculation path 152 is connected downstream side of the intercooler 50, the temperature of the oxidant gas sucked in by the compressor 22 is lowered. Thus, the energy required to achieve a predetermined pressure ratio in the compressor 22 can be reduced.

### Example 3

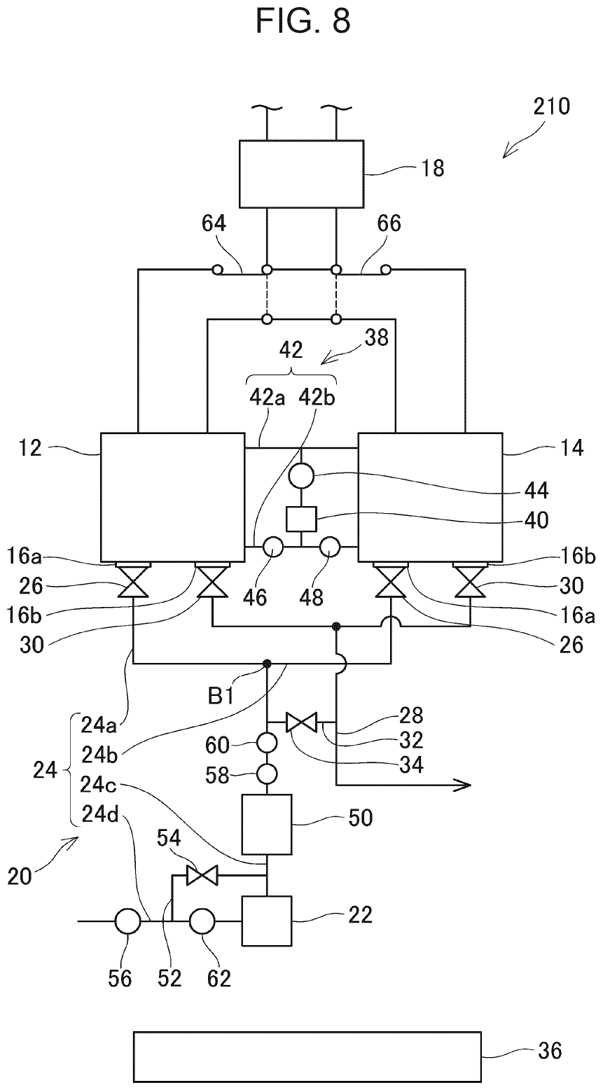

Referring to FIG. 8, a fuel cell system 210 according to a third embodiment will be described. As shown in FIG. 8, in the fuel cell system 210 of the third embodiment, a plurality of fuel cell stacks 12 and 14 are electrically connected in series as compared with the fuel cell system 10 of the first embodiment. The remainder of the configuration is the same as that of the fuel cell system 10 of the first embodiment, and therefore, a repetitive description thereof will be omitted here.

As illustrated in FIG. 9, the fuel cell system 210 further includes a first relay 64 and a second relay 66. The first relay 64 is provided between one pole of the first fuel cell stack 12 and one pole of the power control unit 18, and the second relay 66 is provided between the other pole of the second fuel cell stack 14 and the other pole of the power control unit 18. As shown in FIG. 9, when the first relay 64 and the second relay 66 are both in the first state, the first fuel cell stack 12 is electrically connected in series with the second fuel cell stack 14. When the first relay 64 is in the first state and the second relay 66 is in the second state (the position indicated by the dotted line), the fuel cell system 10 supplies only the output from the first fuel cell stack 12 to the outside. When the second relay 66 is in the first state and the first relay 64 is in the second state (the position indicated by the dotted line), the fuel cell system 10 supplies only the output from the second fuel cell stack 14 to the outside.

Also in the above configuration, the control device 36 can repeatedly execute the first processing and/or the second processing in the first embodiment. Thus, surging of the compressor 22 can be avoided.

In addition, in the fuel cell system 210 of the third embodiment, the position where the recirculation path 52 is provided can be changed. That is, as another embodiment, a fuel cell system in which a plurality of fuel cell stacks 12 and 14 are electrically connected in series may be employed as compared with the fuel cell system 110 of the second embodiment. Also in this configuration, the control device 36 can repeatedly execute the first processing and/or the second processing in the first embodiment, and can avoid surging of the compressor 22.

While several specific examples have been described in detail above, these are merely illustrative and do not limit the scope of the claims. The technique described in the claims includes various modifications and variations of the specific examples exemplified above. The technical elements described in this specification or in the drawings may be used alone or in combination to achieve technical usefulness.

What is claimed is:

1. A fuel cell system comprising:
a plurality of fuel cell stacks;
an oxidant gas supply unit having a turbo compressor that supplies an oxidant gas to each of the fuel cell stacks; and
a control device that determines a required operation number for the fuel cell stacks and a target supply pressure and target supply flow rate of the oxidant gas to be commanded to the oxidant gas supply unit in accordance with a required output, wherein
the oxidant gas supply unit has an adjustment mechanism that adjusts a supply rate being a ratio of a supply flow rate supplied to the fuel cell stacks with respect to a discharge flow rate of the turbo compressor, and
the control device monitors a pressure ratio in the turbo compressor, and reduces the supply rate by controlling the adjustment mechanism when the pressure ratio exceeds a predetermined threshold.

2. The fuel cell system according to claim 1, wherein the adjustment mechanism includes
a recirculation path that connects a discharge side and a suction side of the turbo compressor to each other, and
a flow rate adjustment valve provided in the recirculation path.

3. The fuel cell system according to claim 2, wherein:
the oxidant gas supply unit further includes an intercooler that cools the oxidant gas discharged from the turbo compressor; and
the recirculation path connects the discharge side and the suction side of the turbo compressor to each other on an upstream side of the intercooler.

4. The fuel cell system according to claim 2, wherein:
the oxidant gas supply unit further includes an intercooler that cools the oxidant gas discharged from the turbo compressor; and
the recirculation path connects the discharge side and the suction side of the turbo compressor to each other on a downstream side of the intercooler.

5. The fuel cell system according to claim 1, wherein:
the oxidant gas supply unit includes
an oxidant gas supply path that supplies the oxidant gas from the turbo compressor to the fuel cell stacks, and
an off-gas discharge path that discharges an off-gas of the oxidant gas from the fuel cell stacks; and
the adjustment mechanism includes a flow dividing path that connects the oxidant gas supply path and the off-gas discharge path to each other, and a flow rate adjustment valve provided in the flow dividing path.
